(19) United States
(12) Patent Application Publication
(10) Pub. No.: US 2017/0293792 A1
(43) Pub. Date: Oct. 12, 2017

(54) FINGERPRINT AUTHORISABLE DEVICE

(71) Applicant: Zwipe AS, Oslo (NO)

(72) Inventor: Jose Ignacio Wintergerst Lavin, Colorado Springs, CO (US)

(21) Appl. No.: 15/483,517

(22) Filed: Apr. 10, 2017

Related U.S. Application Data
(60) Provisional application No. 62/320,711, filed on Apr. 11, 2016.

(30) Foreign Application Priority Data
May 10, 2016 (GB) 1608174.7

(51) Int. Cl. G06K 9/00; G06K 19/077

(52) U.S. Cl. CPC G06K 9/00053; G06K 9/0002; G06K 9/00087; G06K 19/07722

(57) ABSTRACT

A fingerprint author sable device including a control system for controlling the device, where the control system is arranged to provide access to one or more functions of the device in response to identification of an authorized fingerprint, and a fingerprint sensor assembly including a fingerprint sensor for obtaining fingerprint data for use in the fingerprint authorization, where the fingerprint sensor assembly further includes a protective layer located on top of a sensing surface of the fingerprint sensor, the protective layer including a scratch resistant material.

### CROSS REFERENCE TO RELATED APPLICATIONS

This application is related to and claims the benefit of U.S. Provisional Application No. 62/320,711 filed on 11 Apr. 2016 and Great Britain Patent Application Number 1608174.7 filed on 10 May 2016, the contents of both of said applications are herein incorporated by reference in their entirety.

### TECHNICAL FIELD

The present invention relates to a fingerprint author sable device and to a method for controlling a fingerprint author sable device.

### BACKGROUND

Fingerprint authorized devices such as smartcards are becoming increasingly more widely used. Smartcards for which biometric authorization has been proposed include, for example, access cards, credit cards, debit cards, pre-pay cards, loyalty cards, identity cards, cryptographic cards, and so on. Smartcards are electronic cards with the ability to store data and to interact with the user and/or with outside devices, for example via contactless technologies such as RFID. These cards can interact with sensors to communicate information in order to enable access, to authorize transactions and so on. Other devices are also known that make use of biometric authorization such as fingerprint authorization, and these include computer memory devices, building access control devices, military technologies, vehicles and so on.

The addition of fingerprint sensors and the associated electronics to devices such as smartcards leads to increased complexity and therefore an increased risk of failure and/or damage.

### BRIEF SUMMARY

Viewed from a first aspect the present invention provides a fingerprint author sable device comprising: a control system for controlling the device, wherein the control system is arranged to provide access to one or more functions of the device in response to identification of an authorized fingerprint; and a fingerprint sensor assembly including a fingerprint sensor for obtaining fingerprint data for use in the fingerprint authorization, wherein the fingerprint sensor assembly further includes a protective layer located on top of a sensing surface of the fingerprint sensor, the protective layer comprising a scratch resistant material.

The use of an added protective layer in the fingerprint sensor assembly provides significant advantages in terms of prolonging the lifespan of the fingerprint sensor and protecting it from damage. Fingerprint sensors are normally manufactured with a hard and scratch resistant surface coating for this purpose. However, the inventor has made the realization that this surface is still susceptible to damage, especially in the case where the fingerprint author sable device may be used frequently, such as in the example of a smartcard that could be used many times each day. Consequently, it is highly advantageous to include an additional protective layer, which is in addition to or potentially a substitute for the normal protective coatings of the fingerprint sensor.

It is important for the sensing surface of the fingerprint sensor to be protected against electrostatic discharge as well as scratches, impact, and every-day wear and tear.

No matter where a fingerprint sensor is deployed, the sensor will undergo wear and tear as users place their fingers on the device for identification of an authorized fingerprint. As a consequence, fingerprint sensors can have shortened life spans due to the fact that a user must make physical contact in order for the device to successfully capture a fingerprint to provide identification verification. In many situations users of the fingerprint author sable device may be prone to having dirty, greasy, or grimy fingers due to their job responsibilities or due to their daily activities. This can be in context of a specific role, such as within a factory where fingerprint author sable devices are used, or it may be from day-to-day activities such as handling foods. Whilst it can be recommended that such users clean their hands (or at least their enrolled digit) before attempting to authenticate, this advice will not always be followed. Dirty residue, oils or other materials on the surface of a fingerprint sensor can obscure the fingerprint image causing performance degradation in terms of false acceptance and false reject rates. Furthermore, a user might prefer to keep the fingerprint author sable device clean and again whilst they might be advised not to use certain products it is possible that this advice would be ignored leading to the use of cleaning solvents (especially those that are alcohol- or ammonia-based) that may damage the sensing surface of the fingerprint sensor. The repeated use of such products will lead to the sensor's protective layer becoming damaged. Such damage will result in decreased capture sensitivity, and will negatively impact the sensor's performance. The addition of a further protective layer as described above will reduce or completely avoid these problems.

In some examples the fingerprint sensor is a pre-existing product, i.e. “off-the-shelf” and the protective layer is added on top of the existing surface of the fingerprint sensor. In alternative implementations the fingerprint sensor assembly may comprise a modified fingerprint sensor product in which an additional protective layer is incorporated at the top of the fingerprint sensor above the fingerprint sensing surface either in addition to pre-existing coatings that might be applied, or as a substitute for such coatings. Thus, it will be understood that the protective layer may be separate to the fingerprint sensor or it could be incorporated as an integral part of the finger print sensor. The protective layer is however always an added material of significant thickness, for example at least 200 μm and possibly at least 300 μm, with protective properties going beyond those of protective coatings that are conventionally used with fingerprint sensors. In some cases the protective layer may have a comparable thickness to the underlying fingerprint sensor component

Preferably the protective layer has a thickness of 500 μm or less, for example a thickness of about 400 μm or less. This means that the addition of the protective layer does not generate any significant disadvantage in relation to the overall thickness of the fingerprint sensor assembly, and the fingerprint author sable device may hence be a device where the thickness of the sensor assembly is significant, for example an electronic card such as a smartcard as discussed below.

The protective layer can be made of any suitable scratch resistant material that is compatible with the fingerprint sensor. Thus, the protective layer may for example have suitable dielectric properties for operation with a passive or active capacitance fingerprint sensor. The protective layer may have a hardness sufficient to provide a Vickers hardness test rating of at least 500, preferably at least 600. A ceramic material may be used. Ceramics can provide the required hardness and scratch resistance in combination with a suitable dielectric properties. In some examples the protective layer is a glass material, such as a chemically toughened glass as discussed below.

The protective layer may comprise chemically toughened glass. A graded zirconia glass may be used. One possible material is alkali-aluminosilicate sheet glass, such as the glass sold under the trade name Gorilla Glass™ and manufactured by Corning Inc. of New York, USA. This type of glass is commonly used as a cover glass for touch screens on mobile devices such as smartphones and other similar cover glass products could be used for the protective layer. Thus, the protective layer may be made of a glass suitable for and/or prepared for use as cover glass for mobile devices. These types of glass have the required scratch resistance and other properties to allow for suitably thin layers and they also are compatible with fingerprint sensors such as sensors based on capacitive effects, hence allowing unimpeded operation of the fingerprint sensors whilst also protecting the more sensitive surface of the sensor from possible damage due to contaminants on the user's finger and/or the use of cleaning materials or cleaning products that could harm the sensor surface.

The protective layer may have an outer surface that is oleophobic. This allows the protective layer to resist damage arising from fingerprint oil as well as other contaminants that may be transferred to fingerprint sensor assemblies from the user's finger or otherwise during use of the fingerprint author sable device. The required oleophobic properties can be provided by the use of cover glass products designed for mobile devices as described above. Alternatively or additionally an oleophobic coating may be included at the outer surface of the protective layer.

The sensing surface of the fingerprint sensor is typically a flat area directed outward from the device allowing easy access for the user's finger or thumb to be placed on the sensing surface. The protective layer is on top of the sensing surface and may cover all of the exposed area of the sensing surface in order to prevent direct contact of the user's finger or any other object or material with the sensing surface. The protective layer has an inner surface adjacent the sensing surface and an outer surface directed outward from the device. The protective layer is advantageously of uniform thickness and hence the outer surface of the protective layer may be parallel with the sensing surface of the fingerprint sensor. The protective layer may be about the same size as the sensing surface of the fingerprint sensor. Typical fingerprint sensors have a rectangular surface and the protective layer may also have a rectangular shape.

The fingerprint sensor assembly may comprise a suitable enclosure for holding the protective layer in place. It is preferred for both of the protective layer and the fingerprint sensor to be held by the same enclosure. In some examples the protective layer (and optionally also the sensor) is secured to the fingerprint author sable device by an outer bezel that encloses some or all of the outer periphery of the protective layer and includes a side wall topped by a lip that extends across an outer rim of the exposed surface of the protective layer. In example embodiments the outer bezel of the fingerprint sensor assembly extends around the entire outer periphery of the protective layer. The shape of the outer bezel may be complementary to the shape of the protective layer, and hence for example when the protective layer is rectangular then the outer bezel is also of rectangular shape. The outer bezel can advantageously be an electrical conductor and be electrically connected to the device such that it acts to provide an electrical field for the fingerprint sensor, for example an electrical field to provide the required capacitive effects for detecting the fingerprint features using an active capacitance sensor. The bezel may hence be metal or any other conductive material, such as a conductive plastic or ceramic material.

The fingerprint author sable device may include an electronic circuit incorporating the fingerprint sensor and the control system. The electronic circuit may include a circuit board, and advantageously this may be a flexible printed circuit board. This allows the device to be flexible, for example to meet requirements such as ISO 7816 relating to smartcards. The fingerprint sensor may be mechanically attached to the circuit board and also electrically attached, advantageously using the same attachment mechanism for both the mechanical and the electrical attachment, for example by using surface mount technology, solder or conductive adhesive. The outer bezel may be mechanically attached to the circuit board and also electrically attached, advantageously using the same attachment mechanism for both the mechanical and the electrical attachment, for example by using surface mount technology, solder or conductive adhesive. The fingerprint sensor and/or the bezel may be attached to the circuit board via an inner casing. The inner casing may form a part of the bezel and/or may provide for mechanical and/or electrical coupling of the bezel to the circuit board.

In an advantageous example the fingerprint sensor assembly thus includes a two part enclosure for the fingerprint sensor. Preferably this two part enclosure also holds the protective layer. The two part enclosure may comprise an inner casing for attachment to a circuit board of the fingerprint author sable device and for enclosing the fingerprint sensor; and an outer bezel for retaining the fingerprint sensor within the inner casing, wherein the outer bezel is arranged to be coupled to the inner casing. The outer bezel can advantageously also retain the protective layer and/or act as a conductive element to provide an electrical field for the fingerprint sensor as discussed above. The shape and other features of the outer bezel in this two part enclosure may be as discussed above. The inner casing and/or the outer bezel can act as a reinforcement member for protection of the fingerprint sensor as described below.

This arrangement has particular advantages where the fingerprint author sable device is required to be flexible, for example in the case of an electronic card such as a smartcard, and hence the circuit board can be a flexible circuit board, such as a so called flexible printed circuit board assembly (FPCBA).

The inner casing and/or the outer bezel of the two part enclosure may have a shape corresponding to the shape of the fingerprint sensor. Thus, in the common example of a rectangular fingerprint sensor the inner casing and/or the outer bezel may have a rectangular shape. It is preferred for the inner casing and the outer bezel to have a similar shape and to be arranged for complementary fit with one another. For example, the outer bezel may be the same shape as the inner casing, but slightly larger so as to fit around the outside of the inner casing.

The inner casing may have side walls that extend away from the surface of the circuit board and at least partially enclose the fingerprint sensor and optionally the protective layer. The side walls may extend away from the surface of the circuit board a sufficient distance so that the top of the fingerprint sensor and/or the top of the protective layer are not exposed above the side walls. Preferably there is an opening in the side wall of the inner casing for allowing electrical connections between the circuit board and the fingerprint sensor. In the example of a rectangular inner casing the casing may have side walls about three sides of the rectangle with the fourth side of the rectangle having no side wall, or only a partial side wall. The inner casing may alternatively or additionally include conductive elements for making an electrical connection to the circuit board. This may be for connections to the fingerprint sensor and/or for an electrical connection to the outer bezel.

The outer bezel may enclose some or all of the outer periphery of the inner casing and preferably includes a side wall topped by a lip that extends across an outer rim of the exposed surface of the fingerprint sensor and/or protective layer. The outer bezel may hence have a side wall extending from the lip toward the circuit board. An inner surface of the side wall of the outer bezel preferably fits in close proximity to an outer surface of the side wall of the inner casing. Advantageously, the side wall of the outer bezel may extend across the opening in the side wall of the inner casing, thereby ensuring that the fingerprint sensor is enclosed on all sides. The outer bezel can be fitted after any required electrical connections are made through the opening in the side wall of the inner casing. In example implementations the bezel has a side wall and/or lip that extends continuously around the entire periphery of the fingerprint sensor and/or protective layer.

The outer bezel may be arranged to be coupled to the inner casing via any suitable connection. Preferably the connection is both mechanical and electrical, thereby securing the outer bezel in place and allowing for it to be electrically coupled to the circuit board via the inner casing. The connection may be via an interference fit and/or through inter-coupling of resilient elements. For example, the connection may involve lugs on one of the two parts arranged to be received in recesses of the other of the two parts, where one or both parts is arranged to deform elastically during assembly to thereby provide a “snap-fit”. Other types of snap-fit connection may be used. The connection may alternatively or additionally use surface mount technology, solder and/or conductive adhesives.

The use of a two part enclosure in combination with a protective layer ensures that the fingerprint sensor can be protected from damage to its surface as well as protected from torsion/bending forces when the fingerprint author sable device is in use and is bent or twisted. By having an inner casing and outer bezel that couple together the manufacture of the fingerprint sensor assembly is straightforward in terms of both of the electrical or the mechanical connections, and the protective layer can easily be secured in place with minimal risk of damage to the fingerprint sensor.

The fingerprint author sable device may be an electronic card. The electronic card may comprise a card body having a cavity formed therein for the fingerprint sensor assembly; and an electronic circuit embedded within the card body, the electronic circuit preferably being a circuit board as discussed above. The circuit may include one or more contacts that are exposed by or accessible by the cavity. The cavity may be formed in an outer layer of the card body either before or after attachment of the outer layer to other components of the electronic card. One example electronic card includes a flexible circuit board, for example as described above; an upper card body layer; and a lower card body layer; wherein the upper and lower card body layers are laminated around and to the flexible circuit board to thereby assemble the electronic card. The upper and lower directions in this discussion are defined with respect to upper and lower surfaces of the flexible circuit board, with the upper surface being the surface to which the fingerprint sensor assembly is attached. Thus, the cavity may be in the upper card body layer.

The card may comprise a transition member mounted within the cavity adjacent the fingerprint sensor assembly and electrically connecting the fingerprint sensor assembly to the circuit.

In accordance with this configuration, contacts for connection of the fingerprint sensor assembly to the circuit are formed on a transition member adjacent the fingerprint sensor assembly, i.e. with the fingerprint sensor assembly and transition member preferably side-by-side. These contacts, and the material bonding them together (such as a conductive epoxy), have a significant thickness relative to the thickness of the overall card. In the proposed configuration, the contact pads are no longer between the fingerprint sensor assembly and the circuit board, allowing the rear of the fingerprint sensor assembly to be positioned physically closer to the circuit board. The thickness of the fingerprint sensor assembly influences the thickness of the card as a whole; thus this configuration may allow the card to be made thinner.

The rear/lower face of the fingerprint sensor assembly may be in contact with or (directly) bonded to the circuit board. For example, it may include a thin layer of adhesive (e.g. an epoxy or the like) bonding the circuit to the substrate. This configuration achieves minimal thickness.

Preferably, the contacts of the transition member are formed on a rear face of the transition member. That is to say, towards the rear with respect to the orientation of the fingerprint sensor assembly, where the front face thereof is the face presented to the user of the fingerprint sensor assembly. Preferably, the rear surface of the transition member is offset away from the circuit board with respect to the rear surface of the fingerprint sensor assembly. This arrangement allows space for the contacts to engage without causing unnecessary thickness.

One or more additional electronic components may also be embedded within the card body and connected to the circuit for processing biometric data received from the biometric sensor. The card body may be formed integrally about the embedded components, for example by lamination. The card body may be formed prior to the inclusion of the fingerprint sensor and/or protective layer. A cavity may be formed within the card body to expose the one or more contacts and allow for attachment of the fingerprint sensor.

In example embodiments, the electronic components include a memory and processor connected to the circuit, the memory being for storing reference fingerprint data and the processor being configured to compare biometric fingerprint data received from the sensor with the stored reference data.

The circuit may include an antenna for wireless communication with a card reader, for example using RF communication. Thus, the card may be an RFID card. The card may or may not include a battery for powering the RF communication.

In various embodiments, the card body is formed from plastic such as PVC or PE.

Thus, the upper card body layer and lower card body layer mentioned above may be PVC or PE. PVC is most commonly used.

In some embodiments, the contacts of the transition member are connected to the contacts of the circuit using an anisotropic conductive adhesive, which is preferably epoxy-based. An anisotropic conductive adhesive conducts only in one direction, i.e. the thickness direction. This means that the anisotropic conductive adhesive does not conduct between adjacent contacts, even if connected by the adhesive. This is particularly important when using a transition member because the transition member desirably has a relatively narrow width, compared to the fingerprint sensor, and so may have a higher density of contacts than if the contacts were arranged across a lower part of the fingerprint sensor assembly.

The card may further comprise a reinforcement member configured to protect the fingerprint sensor assembly, preferably against bending moments. The bezel and/or the inner casing described above may form the reinforcement member. The fingerprint sensor is relatively weak compared to the main body of the card, and bending in particular can damage a fingerprint sensor. The addition of a reinforcement member, advantageously one that also forms a bezel for retaining the fingerprint sensor and protective layer, can reduce the risk of damage to the sensor when bending by increasing the stiffness of the card at the location of the fingerprint sensor assembly, and hence reducing the bending forces applied to the sensor.

The reinforcement member may also reinforce the transition member, where present, and particularly may reinforce the electrical connection between the transition member and the fingerprint sensor assembly. The connection means (e.g. fine wires or the like) will typically extend length-ways along the card and between the fingerprint sensor assembly and the transition module, and may be close to the face of the card. Thus, length-ways bending of the card could put high strain on these connections. The reinforcement member reduces such forces, by stiffening the card at this location, reducing the bending effect that could pull the biometric sensor away from the transition member.

The reinforcement member is preferably made of metal, such as steel (e.g. stainless steel) or copper. Metal has much higher resistance to bending than typical materials used to make such cards, e.g. PVC or other plastics materials.

Where the fingerprint sensor is an active capacitance fingerprint sensor, the reinforcement member may be configured to operate as an electrode of the sensor. For example, the reinforcement member may comprise a conductive surface on the front face of the card for contact with the finger. Again this functionality may be combined with use of the bezel as the reinforcement member. Compared to normal electrodes, the reinforcement member may be thicker in cross-section, or may surround a greater amount of the sensor in order to provide the reinforcement effect. In preferred embodiments, the reinforcement member completely surrounds the fingerprint sensor (and the transition member, if present).

The reinforcement member may comprise a planar portion adjacent a front face of the fingerprint sensor assembly and surrounding adjacent a sensing area of the fingerprint sensor assembly. The planar portion may form a rectangular plate, and in one configuration has a central hole for the sensing area to be exposed, for example a rectangular hole.

The reinforcement member may comprise an edge portion adjacent the sides of the fingerprint sensor assembly and the transition member. The edge portion may form a closed shape around all sides of the fingerprint sensor assembly and transition member.

For example, a tubular, rectangular shape.

In one embodiment the reinforcement member comprises both the planar portion and the edge portion, with the edge portion extending away from the plane of the planar portion. These portions may be integrally connected such that the reinforcement member has an open, box-like structure.

The reinforcement member, in one example takes the form of an open frame with one or more sides of the frame having an inverted, L-shape section (i.e. with the bottom of the L-shape at the front of the card), preferably with the planar portion forming a horizontal of the inverted L-shape and the edge portion forming a vertical of the inverted L-shape. This shape has been found to be highly effective at protecting the biometric sensor and transition member against damage.

The thickness of the, or each, of the planar portion and/or the edge portion may be at least 0.05 mm.

The electronic card may be a smartcard such as any of: an access card; a credit card; a debit card; a pre-pay card; a loyalty card; an identity card; and a cryptographic card.

The electronic card is preferably arranged to be inoperable if the fingerprint sensor does not provide an indication of an authorized user.

The authorized user may initially enroll their fingerprint with the device, optionally indirectly through some other device, but preferably directly onto the device via the fingerprint sensor, and may then typically be required to place their finger or thumb on the fingerprint sensor in order to authorize some or all uses of the device. A fingerprint matching algorithm in the control system may be used to identify a fingerprint match between an enrolled user and a fingerprint sensed by the fingerprint sensor.

It is preferred for the device to be arranged so that it is impossible to extract the data used for identifying users via fingerprint and/or non-fingerprint authorization, example by a fingerprint template or the like. The transmission of this type of data outside of the device is considered to be one of the biggest risks to the security of the device.

To avoid any need for communication of the fingerprint data outside of the device then the device may be able to self-enroll, i.e. the control system may be arranged to enroll an authorized user by obtaining fingerprint data via the fingerprint sensor. This also has advantages arising from the fact that the same sensor with the same geometry is used for the enrollment as for the fingerprint authorization. The fingerprint data can be obtained more consistently in this way compared to the case where a different sensor on a different device is used for enrollment. With fingerprint biometrics, one problem has been that it is difficult to obtain repeatable results when the initial enrollment takes place in one place, such as a dedicated enrollment terminal, and the subsequent enrollment for matching takes place in another, such as the terminal where the matching is required. The mechanical features of the housing around each fingerprint sensor must be carefully designed to guide the finger in a consistent manner each time it is read by any one of multiple sensors. If a fingerprint is scanned with a number of different terminals, each one being slightly different, then errors can occur in the reading of the fingerprint. Conversely, if the same fingerprint sensor is used every time then the likelihood of such errors occurring is reduced.

In accordance with the proposed device, both the matching and enrollment scans may be performed using the same fingerprint sensor. As a result, scanning errors can be balanced out because, for example, if a user tends to present their finger with a lateral bias during enrollment, then they are likely to do so also during matching. This self-enrollment also means that any effect on the fingerprint data from the enclosure or the protective layer will be present in both the enrolled data and the fingerprint data used for authentication.

The control system may have an enrollment mode in which a user may enroll their fingerprint via the fingerprint sensor, with the fingerprint data generated during enrollment being stored on the memory. The control system may be arranged to prompt the user for enrollment of a non-fingerprint authorization code in addition to fingerprint enrollment (i.e. to allow for later failures in fingerprint authorization) and/or in the event of a failure to enroll the user.

The control system may be in the enrollment mode when the device is first provided to the user, so that the user can immediately enroll their fingerprint data. The first enrolled user may be provided with the ability to later prompt an enrollment mode for subsequent users to be added, for example via input on an input device of the device after identification has been confirmed. Alternatively or additionally it may be possible to prompt the enrollment mode of the control system via outside means, such as via interaction between the device and a secure system, which may be a secure system controlled by the manufacturer or by another authorized entity.

The control system may include a fingerprint processor for executing the fingerprint matching algorithm and a memory for storing fingerprint data for enrolled fingerprints. The control system of the device may include multiple processors, wherein the fingerprint processor may be a separate processor associated with the fingerprint sensor. Other processors may include a control processor for controlling basic functions of the device, such as communication with other devices (e.g. via contactless technologies), activation and control of receivers/transmitters, activation and control of secure elements such as for financial transactions and so on. The various processors could be embodied in separate hardware elements, or could be combined into a single hardware element, possibly with separate software modules.

The fingerprint author sable device may be a portable device, by which is meant a device designed for being carried by a person, preferably a device small and light enough to be carried conveniently. The device can be arranged to be carried within a pocket, handbag or purse, for example. The device may be a smartcard such as a fingerprint author sable RFID card. The device may be a control token for controlling access to a system external to the control token, such as a one-time-password device for access to a computer system or a fob for a vehicle keyless entry system. The device is preferably also portable in the sense that it does not rely on a wired power source. The device may be powered by an internal battery and/or by power harvested contactlessly from a reader or the like, for example from an RFID reader.

The device may be a single-purpose device, i.e. a device for interacting with a single external system or network or for interacting with a single type of external system or network, wherein the device does not have any other purpose. Thus, the device is to be distinguished from complex and multi-function devices such as smartphones and the like.

Where the device is a smartcard then as discussed above the smartcard may be any of: an access card, a credit card, a debit card, a pre-pay card, a loyalty card, an identity card, a cryptographic card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where the device is a control token it may for example be a keyless entry key for a vehicle, in which case the external system may be the locking/access system of the vehicle and/or the ignition system. The external system may more broadly be a control system of the vehicle. The control token may act as a master key or smart key, with the radio frequency signal giving access to the vehicle features only being transmitted in response to fingerprint identification of an authorized user. Alternatively the control token may act as a remote locking type key, with the signal for unlocking the vehicle only being able to be sent if the fingerprint authorization module identifies an authorized user. In this case the identification of the authorized user may have the same effect as pressing the unlock button on prior art keyless entry type devices, and the signal for unlocking the vehicle may be sent automatically upon fingerprint or non-fingerprint identification of an authorized user, or sent in response to a button press when the control token has been activated by authentication of an authorized user.

The device may be capable of wireless communication, such as using RFID or NFC communication. Alternatively or additionally the device may comprise a contact connection, for example via a contact pad or the like such as those used for “chip and pin” payment cards. In various embodiments, the device may permit both wireless communication and contact communication.

The present invention also provides, in a second aspect, a method of manufacturing a fingerprint author sable device comprising: a control system for controlling the device, wherein the control system is arranged to provide access to one or more functions of the device in response to identification of an authorized fingerprint; and a fingerprint sensor assembly including a fingerprint sensor for obtaining fingerprint data; wherein the method comprises providing the fingerprint sensor assembly with a protective layer located on top of a sensing surface of the fingerprint sensor, the protective layer comprising a scratch resistant material.

The protective layer may have any or all features as described above in connection with the first aspect and examples/optional features thereof. The fingerprint author sable device may have any or all features described above in connection with the first aspect and examples/optional features thereof. The method may hence include addition of a protective layer to a pre-existing fingerprint sensor product, for example by mounting an additional layer of material atop a fingerprint sensor. Alternatively the method may include manufacture of a fingerprint sensor incorporating a protective layer as described above, for example by adding a further layer to the fingerprint sensor or by replacing an existing protective coating with a protective layer as described herein.

The protective layer and fingerprint sensor (or optionally a fingerprint sensor incorporating the protective layer) may be held on a circuit board by an enclosure optionally including a bezel as described above. The bezel may advantageously be a conductive element of the fingerprint sensor assembly as a part of an active capacitance sensor.

In an advantageous example the fingerprint sensor assembly includes a two part enclosure for the fingerprint sensor and the protective layer. The method may include attaching an inner casing of the two part enclosure to a circuit board of the fingerprint author sable device, the inner casing being for enclosing the fingerprint sensor. The fingerprint sensor may be inserted into the inner casing after attachment of the inner casing to the circuit board, with the protective layer being provided on top of the fingerprint sensor. As noted above the protective layer is a layer of material added to the fingerprint sensor to enhance the robustness of the fingerprint sensor assembly. This may be achieved by adding a separate layer of material to a pre-existing fingerprint sensor, or by adapting the design of a fingerprint sensor to incorporate a separate layer of material during manufacture. The method may hence include either using a suitably adapted fingerprint sensor and inserting this into the inner casing (with the protective layer being a part of the fingerprint sensor), or by inserting a fingerprint sensor into the inner casing and also inserting a protective layer into the inner casing on top of the fingerprint sensor.

The assembly of the two part enclosure may include coupling an outer bezel to the inner casing and retaining the fingerprint sensor and protective layer within the inner casing using the outer bezel. The outer bezel can advantageously act as a conductive element to provide an electrical field for the fingerprint sensor as discussed above. The shape and other features of the inner casing and/or outer bezel in the method may be as discussed above.

The method may include electrically connecting the fingerprint sensor to the circuit board, and this may be done via electrically conductive parts of the inner casing and/or via electrical connections passing through an opening in a side wall of the inner casing as discussed above. The inner casing may have electrically conductive parts and the method can include using the inner casing to provide electrical connections to the fingerprint sensor and/or the outer bezel.

The step of coupling the outer bezel to the inner casing may be carried out after any required electrical connections are made, for example through the opening in the side wall of the inner casing. The coupling of the outer bezel to the inner casing may involve the use of an interference fit and/or inter-coupling of resilient elements. The connection may involve using lugs and recesses as described above.

The method may include providing a card body including an embedded circuit board, wherein a cavity in the card body exposes contacts of a circuit on the substrate; and mounting the fingerprint sensor assembly and a transition member adjacent one another in the cavity such that the transition member electrically connects the fingerprint sensor assembly to the circuit. This method may further involve additional features relating to the transition member as discussed above.

The transition member may be electrically connected to the contacts of the fingerprint sensor before installing the fingerprint sensor and the transition member into the cavity. Alternatively, however, the transition member may be electrically connected to the contacts of the fingerprint sensor after installing the fingerprint sensor and the transition member into the cavity.

The transition member may be bonded or otherwise joined to the fingerprint sensor before installation into the cavity. This provides a single unit to be installed into the card body. Furthermore, the transition member may provide some protection to the relatively-fragile fingerprint sensor against bending.

In other embodiments, the transition member may be bonded to the fingerprint sensor at the same time as the fingerprint sensor is bonded to the card body, e.g. when curing an epoxy holding the fingerprint sensor within the cavity.

Preferably, the transition member is connected to the contacts using a conductive adhesive (e.g. a conductive epoxy). This ensures a good ohmic contact between the sensor and the contacts within the cavity.

The conductive adhesive may be an anisotropic conductive adhesive. As above, the use of anisotropic conductive adhesive means that substantial conduction does not occur between the contacts, even if some of the adhesive spills over between the contacts. This allows more freedom in selecting the technique/apparatus that applies the conductive a, since less accuracy is required.

The method may comprise forming the cavity, preferably by removing material from a preformed card body to form the cavity. Particularly, the cavity may be milled using a suitable milling machine.

### BRIEF DESCRIPTION OF THE DRAWINGS

Certain preferred embodiments on the present invention will now be described in greater detail, by way of example only and with reference to the accompanying drawings, in which:

FIG. 1 illustrates a circuit for a smartcard with a fingerprint sensor;

FIG. 2 illustrates a first example of the smartcard including an external housing;

FIG. 3 illustrates a second example of the smartcard which has been laminated;

FIG. 4 shows a schematic plan view of an inner casing of a fingerprint sensor assembly;

FIG. 5 shows the inner casing of FIG. 4 in side/cross-section view;

FIG. 6 shows a side/sectional schematic view of a flexible printed circuit board fitted with the inner casing and ready to receive a fingerprint sensor and protective layer;

FIG. 7 shows a plan view of an outer bezel for fitting to the inner casing;

FIG. 8 shows a side/section view of the outer bezel of FIG. 7;

FIG. 9 shows the circuit board of FIG. 6 and fitting of the outer bezel to the inner casing;

FIG. 10 shows the side/sectional view of the circuit board of FIG. 6 with the outer bezel fitted to the inner casing; and

FIG. 11 shows a schematic plan view of the circuit board of FIG. 10.

### DETAILED DESCRIPTION

By way of example the invention is described in the context of a fingerprint authorized smartcard that includes contactless technology and uses power harvested from the card reader. These features are envisaged to be advantageous features of one application of the proposed fingerprint sensor assembly, but are not seen as essential features. The smartcard may hence alternatively use a physical contact and/or include a battery providing internal power, for example. The fingerprint sensor assembly 130 described herein can also be implemented with appropriate modifications in any other device or system that uses a fingerprint sensor for fingerprint authorization.

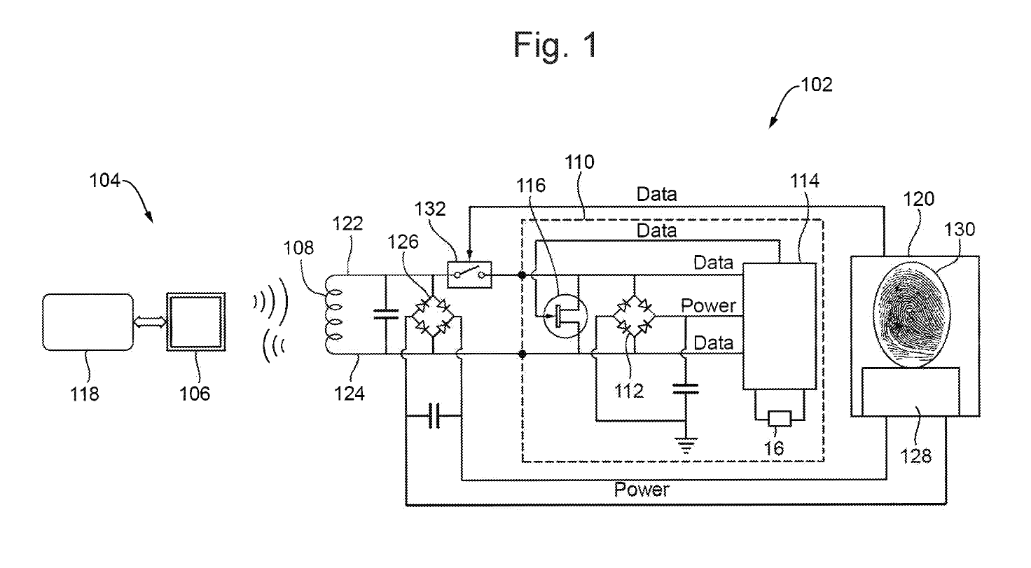

FIG. 1 shows the architecture of a smartcard 102 that is provided with the fingerprint sensor assembly 130. A powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the sensor 104. This type of signaling is known as backscatter modulation and is characterized by the fact that the sensor 104 is used to power the return message to itself.

An accelerometer 16, which is an optional feature, is connected in an appropriate way to the processor 114. The accelerometer 16 can be a Tri-axis Digital Accelerometer as provided by Kionix, Inc. of Ithaca, N.Y., USA and in this example it is the Kionix KXCJB-1041 accelerometer. The accelerometer senses movements of the card and provides an output signal to the processor 114, which is arranged to detect and identify movements that are associated with required operating modes on the card as discussed below. The accelerometer 16 may be used only when power is being harvested from the powered card reader 104, or alternatively the smartcard 102 may be additionally provided with a battery (not shown in the Figures) allowing for the accelerometer 16, and also the related functionalities of the processor 114 and other features of the device to be used at any time.

The smartcard further includes a fingerprint authentication engine 120 including a fingerprint processor 128 and a fingerprint sensor assembly 130. This allows for enrollment and authorization via fingerprint identification. The fingerprint processor 128 and the processor 114 that controls the communication chip 110 together form a control system for the device. The two processors could in fact be implemented as software modules on the same hardware, although separate hardware could also be used. As with the accelerometer 16 (where present) the fingerprint sensor assembly 130 may be used only when power is being harvested from the powered card reader 104, or alternatively the smartcard 102 may be additionally provided with a battery (not shown) allowing power to be provided at any time for the fingerprint sensor assembly 130 and fingerprint processor 128, as well as the processor 114 and other features of the device.

The antenna 108 comprises a tuned circuit including an induction coil and a capacitor, which are tuned to receive an RF signal from the card reader 104. When exposed to the excitation field generated by the sensor 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120.

In this arrangement, a rectifier 126 is provided to rectify the AC voltage received by the antenna 108. The rectified DC voltage is smoothed using a smoothing capacitor and then supplied to the fingerprint authentication engine 120 and other electrical components. Alternatively or additionally a battery may be included as noted above.

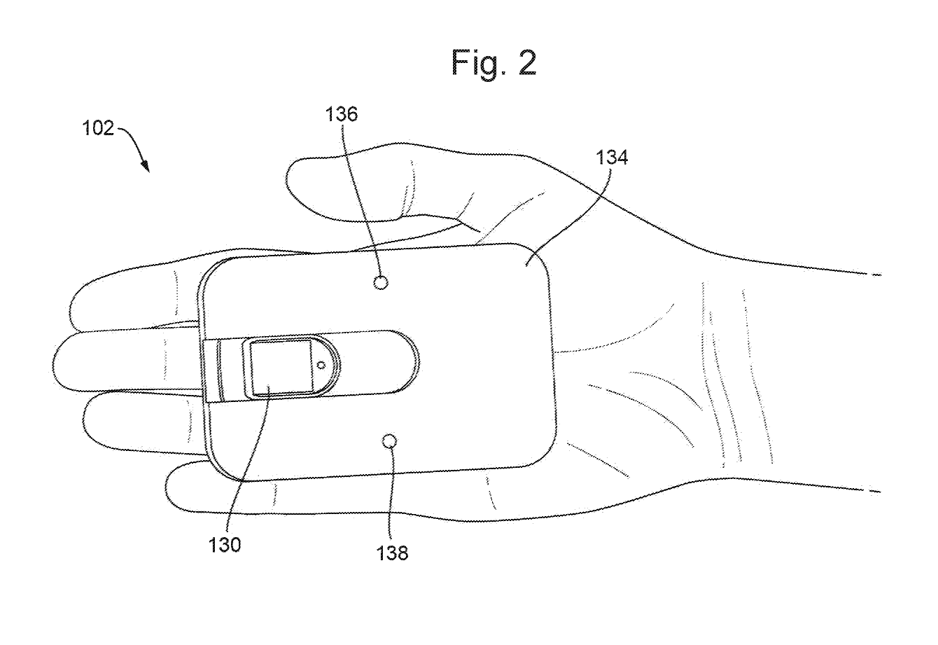

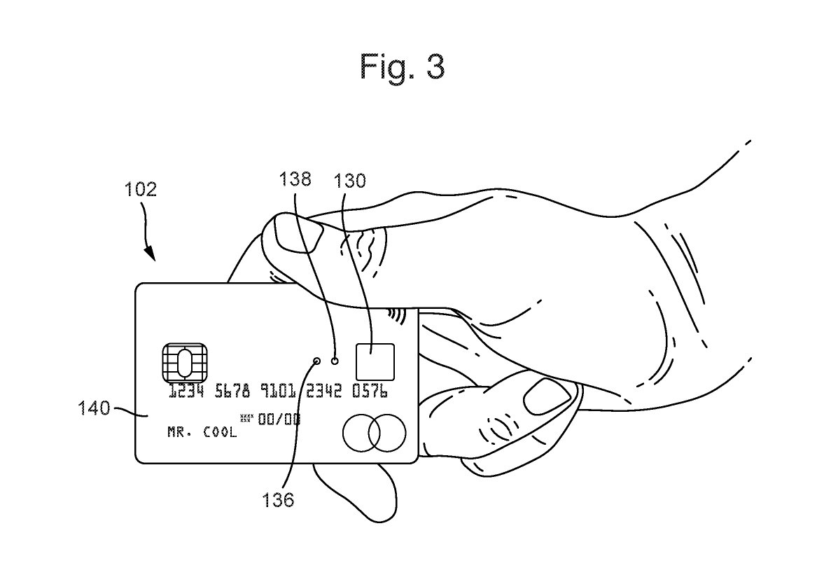

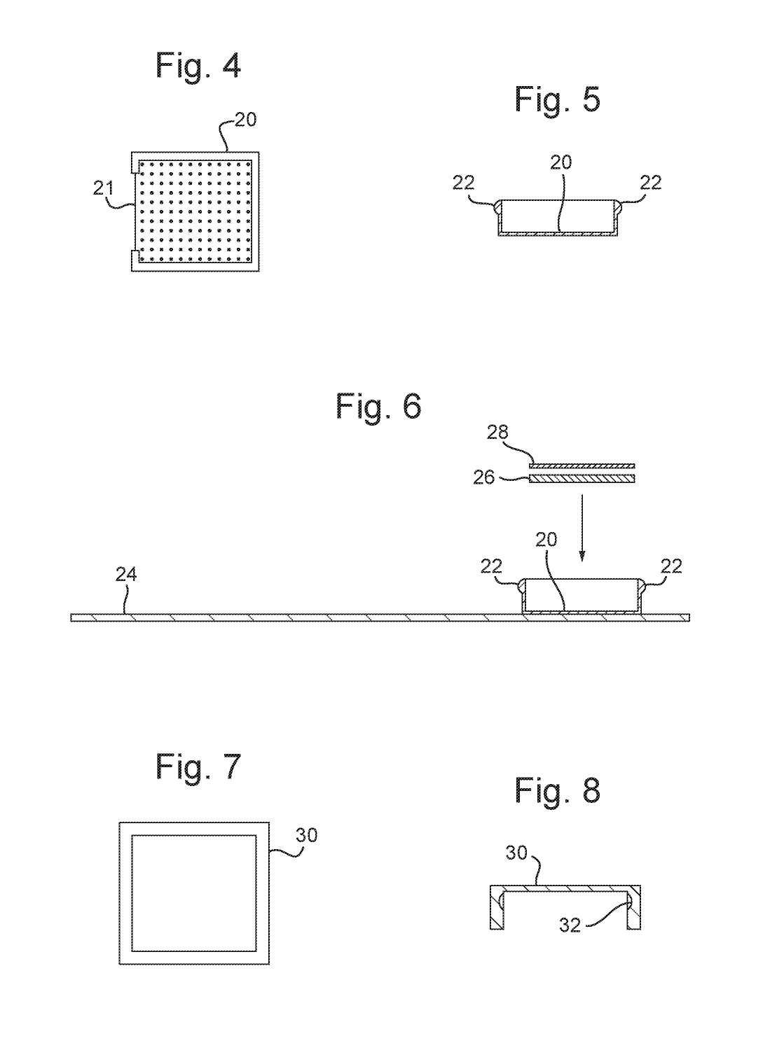

The fingerprint sensor assembly 130, which is described in more detail below with reference to FIGS. 4 to 11, may be mounted on a card housing 134 as shown in FIG. 2 or fitted so as to be exposed from a laminated card body 140 as shown in FIG. 3. The card housing 134 or the laminated body 140 encases all of the components of FIG. 1, and is sized similarly to conventional smartcards. The fingerprint authentication engine 120 may be passive, and hence may be powered only by the voltage output from the antenna 108. Alternatively a battery (not shown) may be provided for powering the fingerprint authorization engine 120. The processor 128 comprises a microprocessor that is chosen to be of very low power and very high speed, so as to be able to perform fingerprint matching in a reasonable time.

The fingerprint authentication engine 120 is arranged to scan a finger or thumb presented to the fingerprint sensor assembly 130 and to compare the scanned fingerprint of the finger or thumb to pre-stored fingerprint data using the processor 128. A determination is then made as to whether the scanned fingerprint matches the pre-stored fingerprint data. In a preferred embodiment, the time required for capturing a fingerprint image and authenticating the bearer of the card 102 is less than one second.

If a fingerprint match is determined and/or if appropriate movements are detected via the accelerometer 16, then the processor takes appropriate action depending on its programming. In this example the fingerprint authorization process is used to authorize the use of the smartcard 104 with the contactless card reader 104. Thus, the communication chip 110 is authorized to transmit a signal to the card reader 104 when a fingerprint match is made. The communication chip 110 transmits the signal by backscatter modulation, in the same manner as the conventional communication chip 110. The card may provide an indication of successful authorization using a suitable indicator, such as a first LED 136.

The fingerprint processor 128 and the processor 114 may receive an indication of a non-fingerprint interaction with the fingerprint sensor assembly 130, which can include any action detectable via the fingerprint sensor assembly 130. The interaction of the user with the card via the fingerprint sensor assembly 130 may be used as a part of a non-fingerprint authorization and also may be used to allow the user to control the smartcard by switching between different operating modes of the smartcard.

In some circumstances, the owner of the fingerprint smartcard 102 may suffer an injury resulting in damage to the finger that has been enrolled on the card 102. This damage might, for example, be a scar on the part of the finger that is being evaluated. Such damage can mean that the owner will not be authorized by the card 102 since a fingerprint match is not made. In this event the processor 114 may prompt the user for a back-up identification/authorization check via an alternative interaction with the smartcard 102, which in this case includes one or more action(s) detected via the fingerprint sensor assembly 130 and also optionally actions detected via other sensors, such as the accelerometer 16. The card may prompt the user to use a back-up identification/authorization using a suitable indicator, such as a second LED 138. It is preferred for the non-fingerprint authorization to require a sequence of interactions with the card by the user, this sequence being pre-set by the user. The pre-set sequence for non-fingerprint authorization may be set when the user enrolls with the card 102. The user can hence have a non-fingerprint authorization in the form of a “password” entered using non-fingerprint interactions with the card to be used in the event that the fingerprint authorization fails. The same type of non-fingerprint authorization can be used in the event that a user is unable or unwilling to enroll with the card 102 via the fingerprint sensor assembly 130.

Thus, as well as allowing communication via the circuit 110 with the card reader 104 in response to a fingerprint authorization via the fingerprint sensor assembly 130 and fingerprint processor 128 the processor 114 may also be arranged to allow such communication in response to a non-fingerprint authorization.

When a non-fingerprint authorization is used the card 102 could be arranged to be used as normal, or it could be provided with a degraded mode in which fewer operating modes or fewer features of the card 102 are enabled. For example, if the smartcard 102 can act as a bank card then the non-fingerprint authorization might allow for transactions with a maximum spending limit lower than the usual maximum limit for the card 102.

The processor 114 receives the output from the accelerometer 16 and this allows the processor 114 to determine what movements of the smart card 102 have been made. The processor 114 identifies pre-set movements and other actions of the user that are linked with required changes to the operating mode of the smartcard. As discussed above, the movements may include any type of or combination of rotation, translation, acceleration, impulse and other movements detectable by the accelerometer 16. The other actions of the user may include actions detected via the fingerprint sensor, such as taps, swipes and so on as discussed above.

The operating modes that the processor 114 activates or switches to in response to an identified movement associated with the required change in operating mode may include any mode of operation as discussed above, including turning the card on or off, activating secure aspects of the card 102 such as contactless payment, or changing the basic functionality of the card 102 for example by switching between operating as an access card, a payment card, a transportation smartcard, switching between different accounts of the same type (e.g. two bank accounts), switching between communications protocols (such as blue tooth, Wifi, NFC) and/or activating a communication protocol, activating a display such as an LCD or LED display, obtaining an output from the smartcard 102, such as a one-time-password or the like, or prompting the card 102 to automatically perform a standard operation of the smartcard 102.

The processor 114 has an enrollment mode, which may be activated upon first use of the smartcard 102. In the enrollment mode the user is prompted to enroll their fingerprint data via the fingerprint sensor assembly 130. This can require a repeated scan of the fingerprint via the fingerprint sensor assembly 130 so that the fingerprint processor 128 can build up appropriate fingerprint data, such as a fingerprint template. After a successful or an unsuccessful enrollment of fingerprint data the user is prompted to enter a non-fingerprint authorization. This could be optional in the case of a successful fingerprint enrollment, or compulsory if the fingerprint enrollment was not successful. The non-fingerprint authorization includes a sequence of interactions with the smartcard 102 including at least one action by the user that is detected via the fingerprint sensor assembly 130. The processor 114 can keep a record of these interactions in a memory, and it is arranged to provide at least partial authorization to use the functions of the card in the event that the non-fingerprint authorization is provided by the user.

The processor 114 can have a learn mode to allow for the user to specify which actions (including combinations of actions/interactions) should activate particular operating modes whilst the smartcard 102 is in use. This type of control of the smartcard 102 might be enabled only after a successful fingerprint or non-fingerprint authorization. In the learn mode the processor 114 prompts the user to make the desired sequence of actions, and to repeat the movements for a predetermined set of times. These movements are then allocated to the required operating mode or to the non-fingerprint authorization. With this latter feature the learn mode can allow for the sequence of movements used for the non-fingerprint authorization to be changed by the user in the same way that a traditional PIN can be changed.

An example arrangement for the fingerprint sensor assembly 130 will now be described with reference to FIGS. 4 to 11. It should be noted that for the sake of clarity the figures are shown in schematic form only with exaggerated scale. It will be appreciated that the actual sizes of the various parts, in particular their heights, are much less that shown and that the parts would fit together more closely than indicated in the drawings.

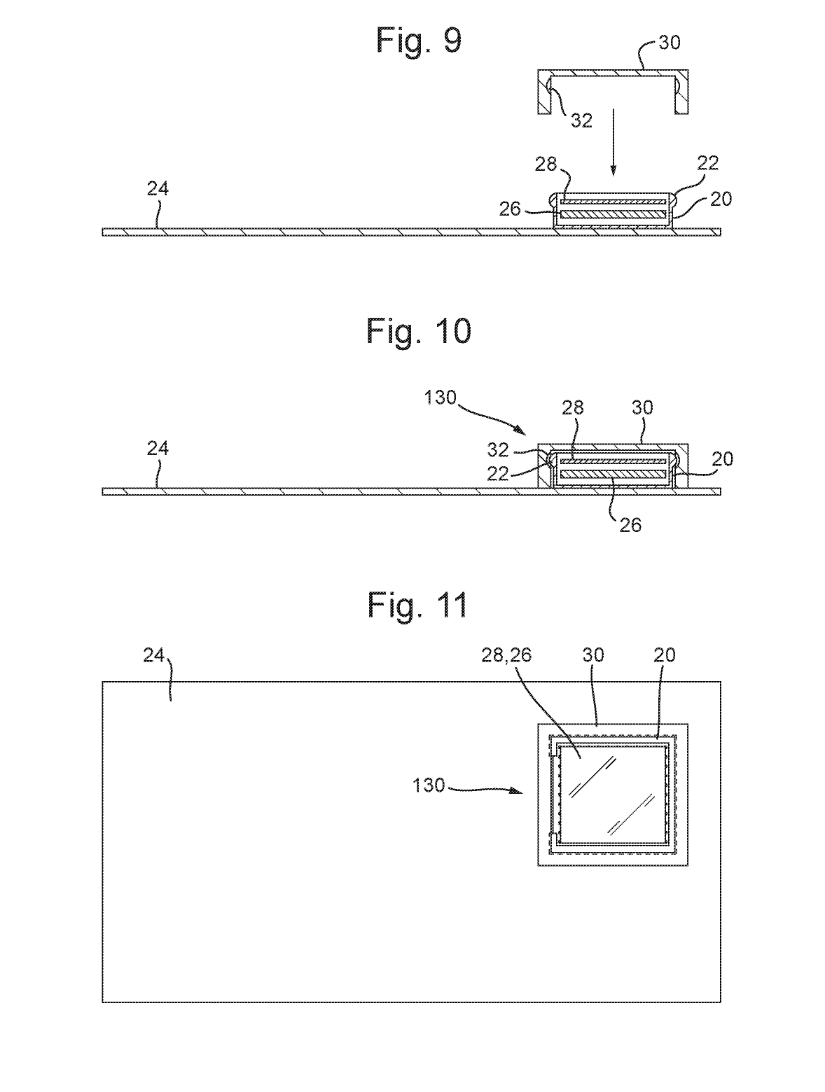

The completed fingerprint sensor assembly 130 is mounted on a circuit board, which in this example is a flexible printed circuit board assembly 24. This is shown schematically in side/section view in FIG. 10 and in plan view in FIG. 11. The fingerprint sensor assembly includes an inner casing 20 which is shown in plan view in FIG. 4 and in cross-section view in FIG. 5. The inner casing is three sided as can be seen in FIG. 4 and also in FIG. 11. Since one side 21 of the inner casing 20 is left open then it is straightforward to connect circuitry from the circuit board 24 to components held within the inner casing 20 since conductive pathways can pass through the open side 21.

The upper edges of the inner casing 20 are in this example provided with protruding lugs 22, which extend around the sides of the inner casing 20. These lugs 22 provide a snap-fit with corresponding recesses 32 on an outer bezel 30 as explained further below.

It should be understood that the lugs 22 and recesses 32 are simply one example of how one might achieve the required interconnections between the inner casing 20 and the outer bezel 30. It would be possible to alternatively have lugs on the outer bezel 30 and recesses on the inner casing 20, or indeed different mechanical arrangements could be used to achieve a suitable snap-fit connection. Couplings known in relation to surface mount technology could be used, or alternatively the connection between the inner casing 20 and the bezel 30 could involve the use of an adhesive or other bonding method.

FIG. 6 shows the inner casing 20 mounted to a flexible printed circuit board assembly 24 and ready to receive a fingerprint sensor 26 and also a protective layer 28. These are inserted through the open top of the inner casing 20 and then connected to circuitry on the flexible circuit board in an appropriate fashion for example by the use of surface mount technology, soldering, or conductive adhesive. The three walls of the inner case 20 are slightly taller than the height of the fingerprint sensor 26 together with the protective layer 28, and this height difference is exaggerated in the Figures. The fingerprint sensor 26 can be an area fingerprint sensor 26 of any suitable type. The protective layer 28 can be any suitably thin scratch resistant material that is compatible with the fingerprint sensor 26 such as, for example chemically toughened glass. One possible material is alkali-aluminosilicate sheet glass, such as the glass sold under the trade name Gorilla Glass™ and manufactured by Corning Inc. of New York, USA. This type of glass is commonly used as a cover glass for touch screens on mobile devices such as smartphones and other similar cover glass products could be used for the protective layer 28. The protective layer 28 is about 400 82 m thick, which means that it can be added on top of suitable a fingerprint sensor 26 without adversely affecting the total width of the fingerprint sensor assembly 130, and in particular whilst allowing the smartcard 102 with the fingerprint sensor assembly 130 to meet the thickness restrictions of ISO 7816.

As noted above an outer bezel 30 is mounted to the inner case 20. The outer bezel 30 is shown in plan view in FIG. 7 and in side/sectional view in FIG. 8. It has four side walls forming an open frame with the sides of the frame having an inverted, L-shape section in order that the bezel 30 surrounds the sides of the fingerprint sensor 26 and the protective layer 28. It also extends across and frames the top of the fingerprint sensor 26 and the protective layer 28. This means that the bezel 30 can act to hold the fingerprint sensor 26 and the protective layer 28 in place, including holding the protective layer 28 firmly against the fingerprint sensor 26. Moreover, in most cases the bezel 30 is made from a conductive material and hence provides the required conductive field for proper functionality of the fingerprint sensor 26 in terms of capturing the fingerprint. The presence of a conductive outer element is a requirement for many types of fingerprint sensor. In the case that the bezel 30 is used as a conductive element then the inner casing 20 can also be made of a conductive material allowing for an electrical connection via the inner casing 20 to the circuit on the circuit board 24. The inner casing 20 can be connected to the circuit board 24 by soldering or via conductive adhesive, for example, in order to both bond the inner casing 20 to the circuit board 24 as well as electrically connecting the inner casing 20 to the circuit which is formed on the circuit board 24.

The bezel 30 is fitted to the inner casing 20 as shown in FIGS. 9 and 10, in this example this is done with a snap-fit utilizing the lugs 22 and corresponding recesses 32. The use of a snap-fit connection, or similar mechanical connection, means that the bezel 30 can be simply pushed into place, whilst the fingerprint sensor 26 and protective layer 28 are already held within the inner casing 20, such that it is simple to both secure the fingerprint sensor 26 and protective layer 28 to the inner casing 20, and to complete the fingerprint sensor assembly 130 by providing a suitable electrically conductive bezel 30, if required, about the fingerprint sensor 26. Moreover, by the use of a two-part bezel assembly made up of the inner casing 20 and the outer bezel 30 then the fingerprint sensor assembly 130 is provided with reinforcement and is well protected from torsional forces that might otherwise be passed to the fingerprint sensor 26 and/or the protective layer 28, which can be relatively fragile in terms of bending and torsion forces. This is particularly helpful in the case of the examples where the fingerprint sensor assembly is used on a smart card 102, especially with a laminated card as shown in FIG. 3. However, the advantages arising from the use of the fingerprint sensor assembly 130 and assembly method described above are also beneficial in other contexts where a fingerprint sensor is used for a biometrically authorized device, for example a control token such as a vehicle keyless entry fob.

Suitable methods for manufacturing various aspects of an electronic card of the type described herein are set forth, for example, in WO2013/160011, U.S. 62/262944, U.S. 62/262,943, U.S. 62/312,773, U.S. 62/312,775 and U.S. 62/312,803.

1. A smartcard comprising:
a control system for controlling the smartcard, wherein the control system is arranged to provide access to one or more functions of the smartcard in response to identification of an authorized fingerprint; and
a fingerprint sensor assembly including a fingerprint sensor for obtaining fingerprint data for use in the fingerprint authorization, wherein the fingerprint sensor assembly further includes a protective layer located on top of a sensing surface of the fingerprint sensor, the protective layer comprising a scratch resistant material.

2. A smartcard as claimed in claim 1, wherein the protective layer has a thickness of 500 μm or less.

3. A smartcard as claimed in claim 1, wherein the protective layer has a hardness sufficient to provide a Vickers hardness test rating of at least 500.

4. A smartcard as claimed in claim 1, wherein the protective layer has suitable dielectric properties for operation with a passive or active capacitance fingerprint sensor.

5. A smartcard as claimed in claim 1, wherein the protective layer comprises or consists of a ceramic material.

6. A smartcard as claimed in claim 1, wherein the protective layer comprises or consists of chemically toughened glass such as graded zirconia glass or alkali-aluminosilicate glass.

7. A smartcard as claimed in claim 1, wherein the protective layer comprises or consists of a material known for use as mobile device cover glass.

8. A smartcard as claimed claim 1, wherein the protective layer has an outer surface that is oleophobic.

9. A smartcard as claimed in claim 1, the fingerprint sensor assembly comprising an enclosure for holding both of the protective layer and the fingerprint sensor.

10. A smartcard as claimed in claim 1, wherein the protective layer is secured to the smartcard by an outer bezel that encloses some or all of the outer periphery of the protective layer and includes a side wall topped by a lip that extends across an outer rim of the exposed surface of the protective layer.

11. A smartcard as claimed in claim 10, wherein the outer bezel is an electrical conductor that is electrically connected to the smartcard such that it acts to provide an electrical field for the fingerprint sensor.

12. A smartcard as claimed in claim 11, comprising an electronic circuit incorporating the fingerprint sensor and the control system, wherein the electronic circuit includes a circuit board, wherein the outer bezel is coupled to an inner casing, wherein the inner casing is attached to the circuit board and encloses the fingerprint sensor, and wherein the outer bezel retains the fingerprint sensor within the inner casing.

13. A smartcard as claimed in claim 12, wherein the outer bezel and the inner casing form a reinforcement member configured to protect the fingerprint sensor assembly against bending moments.

14. A smartcard as claimed in claim 12, wherein the inner casing and the outer bezel have a similar shape and are arranged for complementary fit with one another.

15. A smartcard as claimed in claim 12, wherein the outer bezel is coupled to the inner casing via an interference fit and/or through inter-coupling of resilient elements.

16. A smartcard as claimed in claim 12, wherein the circuit board is a flexible printed circuit board.

17. A smartcard as claimed in claim 1, wherein the fingerprint sensor is a pre-existing product and the protective layer is added on top of the sensing surface of the fingerprint sensor.

18. A smartcard as claimed in claim 1, wherein the control system is arranged to enroll an authorized user by obtaining fingerprint data via the fingerprint sensor such that the device uses the same fingerprint sensor for enrollment and for authentication.

19. A smartcard as claimed in claim 1, wherein the smartcard is any of: an access card;
a credit card; a debit card; a pre-pay card; a loyalty card; an identity card; and a cryptographic card.

20. A method of manufacturing a smartcard comprising: a control system for controlling the smartcard, wherein the control system is arranged to provide access to one or more functions of the smartcard in response to identification of an authorized fingerprint; and a fingerprint sensor assembly including a fingerprint sensor for obtaining fingerprint data; wherein the method comprises providing the fingerprint sensor assembly with a protective layer located on top of a sensing surface of the fingerprint sensor, the protective layer comprising a scratch resistant material.
